(19) United States
(12) Patent Application Publication
(10) Pub. No.: US 2015/0103407 A1
(43) Pub. Date: Apr. 16, 2015

(54) LENS, OPTICAL IMAGING LENS SET AND METHOD FOR FORMING A LENS

(71) Applicant: Shen-Chieh Chen, Taichung City (TW)

(72) Inventor: Shen-Chieh Chen, Taichung City (TW)

(21) Appl. No.: 14/515,547

(22) Filed: Oct. 16, 2014

(30) Foreign Application Priority Data
Oct. 16, 2013 (CN) 201310483867.2

(51) Int. Cl. G02B 1/11; G02B 7/02

(52) U.S. Cl. CPC G02B 1/11; G02B 7/02
USPC 359/601; 359/738; 427/162

(57) ABSTRACT

A lens includes: a lens body, including an optical effective part and an extending part, wherein the extending part surrounds a periphery region of the optical effective part, and the extending part has at least one annular surface; and an opaque layer, disposed on the annular surface of the extending part. An optical imaging lens set includes a barrel; and an imaging component is disposed in the barrel. The imaging component includes at least one lens arranged along an optical axis, and one of these lenses is the lens mentioned above. A method for forming a lens forms the opaque layer on the annular surface of the extending part through a stamping method or through an evaporation method.

### CROSS REFERENCE TO RELATED APPLICATION

This application claims priority from P.R.C. Patent Application No. 201310483867.2, filed on Oct. 16, 2013 the contents of which are incorporated by reference in their entirety.

### BACKGROUND OF THE INVENTION

1. Field of the Invention

The present invention relates to optics devices manufacturing, and more particularly, to a lens, an optical imaging lens set and a method for forming the lens.

2. Description of the Prior Art

A conventional optical imaging lens set is shown in FIG. 1. The optical imaging lens set includes a barrel, a plurality of lenses and a plurality of gaskets, wherein the gasket is either disposed between the barrel and the lens, or disposed between two adjacent lenses. The gasket is made of opaque and anti-reflective materials. When the light passes through the lens and forms an image on an image plane, the light can be reflected or absorbed by the gasket, which prevents the scattered light from irradiating on the image plane and forming a flare, to thereby increase the image quality.

As consumer demands for image quality became higher, and there is a trend towards slimming the size of the optical imaging lens set, the size of the gasket needs to be shrunk while the ability for eliminating scattered light should also be increased. The manufacturing process for forming the gasket becomes more difficult. Moreover, the gasket can only be formed on a flat lens surface. If a lens has a tapered surface, the gasket cannot be formed on the lens conformally, which greatly limits the forming of the gasket. Therefore, a novel method that can assist or even replace the conventional method for eliminating scattered light is desired.

### SUMMARY OF THE INVENTION

The present invention provides a lens, an optical imaging lens set and a method for forming the lens, wherein the gasket does not need to be formed, and scattered light can be effectively eliminated.

One purpose of the present invention is to provide a lens, comprising: a lens body, including an optical effective part and an extending part, wherein the optical effective part is the region that allows light to pass through, the extending part is a ring-shaped structure surrounding the periphery region of the optical effective part, and has an annular surface; and an opaque layer, disposed on at least one annular surface of the extending part.

Preferably, the present invention further comprises an anti-reflective layer disposed on the surface of the optical effective part and the extending part of the lens body.

Preferably, the opaque layer is disposed on the anti-reflective layer which is itself disposed on the annular surface of the extending part.

Preferably, the annular surface of the extending part is a matte surface.

Preferably, the annular surface of the extending part comprises a plate surface, a tapered surface or a combination thereof.

Preferably, the opaque layer comprises ink, paint, and colored particles.

Preferably, the opaque layer is formed on the annular surface through a stamping method utilizing a stamping head, a printing method, an evaporation method, or a sputtering method.

Another purpose of the present invention is to provide an optical imaging lens set comprising: a barrel; and an imaging component, disposed in the barrel. The imaging component comprises at least one lens arranged along an optical axis, and one of these lenses is the lens mentioned above.

Another purpose of the present invention is to provide a method for forming a lens, the method comprising the following steps: a. providing a substrate that includes a ring-shaped recess; b. filling an opaque material in the ring-shaped recess; c. providing at least one stamping head contacting the opaque material, wherein the stamping head has at least one top portion, and the ring-shaped opaque material is attached on the top portion while the stamping head contacts the opaque material; d. making the stamping head with the opaque material contact a lens body, and printing the opaque material on the lens body, wherein the lens body includes an optical effective part and an extending part, the optical effective part is the region that allows light to pass through, the extending part is a ring-shaped structure, surrounding the periphery region of the optical effective part, and having at least one annular surface, and the opaque material is printed on one of the annular surface of the extending part; and e. removing the stamping head, and cooling down the opaque material to form a solid opaque layer.

Preferably, after step b, the method further comprises: b1. scraping the opaque material disposed outside the ring-shaped recess utilizing a scraper.

Preferably, in step a, the outer diameter of the ring-shaped recess of the substrate is larger than the outer diameter of the lens body.

Preferably, in step c, the top portion of the stamping head comprises a concave hole, and the opaque material is attached on the top portion around the concave hole, which is ring-shaped.

Preferably, during step d, the surface of the lens body is pre-processed, and an anti-reflective layer is disposed on the surface of the lens body thereby.

Another purpose of the present invention is to provide a method for forming a lens, the method comprising at least the following steps: a. providing a jig comprising a first plate, wherein the first plate comprises at least one recess disposed on the top surface of the first plate, at least one arc-shaped hole is disposed on the inner surface of the recess, the arc-shaped holes are arranged in a ring-shape and extend through the first plate; b. putting a lens body into the recess of the first plate, the lens body including an optical effective part and an extending part, wherein the optical effective part is the region that allows light to pass through, the extending part is a ring-shaped structure surrounding the periphery region of the optical effective part and having an annular surface, and the position of the extending part corresponds to the position of the arc-shaped hole of the first plate; c. using an evaporation method to either vaporize a liquid opaque material into a gaseous opaque steam or sublimate a solid opaque material into the gaseous opaque steam, wherein the gaseous opaque steam attaches on the lens body through the arc-shaped hole of the first plate, and the gaseous opaque steam is cooled down to form a solid opaque layer.

Preferably, the jig provided in step a further comprises a second plate comprising at least one recess disposed on the top surface of the second plate, and at least one arc-shaped hole disposed on the inner surface of the recess of the second plate, wherein the arc-shaped holes are arranged in a ring-shape and extend through the second plate; during step b, after the first plate and the second plate are separated from each other, the lens body is put into the recess of the first plate, and the second plate is overturned, so the second plate stack on the first plate, the top surface of the second plate contacts the top surface of the first surface, both the bottom surface of the first plate and the second plate face outwards, and the position of the extending part corresponds to the position of the arc-shaped hole of the second plate and the method further comprises the following steps: d. overturning the jig to make the first plate stack on the second plate; and e. using an evaporation method to either vaporize a liquid opaque material into a gaseous opaque steam or sublimate a solid opaque material into the gaseous opaque steam, wherein the gaseous opaque steam attaches on the lens body through the arc-shaped hole of the second plate, and the gaseous opaque steam is cooled down to form a solid opaque layer.

Preferably, the present invention further comprises at least one supporting bump disposed in the recess of the first plate, wherein the extending part of the lens body in the recess of the first plate contacts the supporting bump and is supported by the supporting bump.

In another case, the supporting bumps are disposed in both the recess of the first plate and in the recess of the second plate, respectively, and the extending part of the lens body in the recess of the first plate or in the recess of the second plate contacts the supporting bump and is supported by the supporting bump.

Preferably, during step b, the surface of the lens body is pre-processed, and an anti-reflective layer is disposed on the surface of the lens body.

Preferably, during step c, after the evaporation process is performed, the lens body is rotated by certain angles, and another evaporation process is then performed. Furthermore, the lens body is adsorbed by a vacuum nozzle, and then rotated.

In another case, during step c and step e, after the evaporation process is performed, the lens body is rotated by certain angles, and another evaporation process is then performed. Furthermore, the lens body is adsorbed by a vacuum nozzle, and then rotated.

Preferably, during step b, a protection film is formed on the optical effective part of the lens body, and the lens body is then put into the recess of the first plate.

According to the lens and the optical imaging lens set including the lens of the present invention, the opaque layer disposed on the extending part of the lens body can absorb or reflect scattered light effectively, which prevents scattered light from irradiating on the image plane. Flares are thereby eliminated, which increases the image quality. In addition, since the opaque layer is only formed on the extending part, but not formed on the optical effective part, the emitted light will not be blocked by the opaque layer.

Since the opaque layer has the ability to eliminate scattered light, the number of gaskets can be decreased. In this way, not only can the size of the optical imaging lens set be shrunk, but the manufacturing cost can also be decreased while the yield is increased.

The opaque layer formed on the lens body of the present invention can be formed on a flat surface, a tapered surface, a combination of a flat surface and a tapered surface, or other more complex surfaces. The issue of the gaskets only being formed on a flat surface in the conventional process is resolved. In addition, since the opaque layer can cover more regions of the extending part of the lens body to eliminate scattered light more effectively, the image quality can also be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a conventional optical lens set structure.

FIG. 2A is a 3D schematic diagram illustrating a first example of the present invention.

FIG. 2B is a cross-sectional diagram of the first example of the present invention.

FIG. 3 is a cross-sectional diagram illustrating a second example of the present invention.

FIG. 4 is a cross-sectional diagram illustrating a third example of the present invention.

FIG. 5 is a cross-sectional diagram illustrating a fourth example of the present invention.

FIG. 6 is a cross-sectional diagram illustrating a fifth and sixth example of the present invention.

FIG. 7 is a schematic diagram showing an optical imaging lens set structure of a seventh example of the present invention

FIG. 8 is a schematic diagram showing a ring-shaped recess of a plate filled by a liquid opaque material in an eighth example.

FIG. 9A is a schematic diagram showing a hemispherical stamping head of the eighth example.

FIG. 9B is a schematic diagram showing a bullet-shaped stamping head of the eighth example.

FIG. 10 is a schematic diagram showing a top portion of the stamping head of the present invention attached by the liquid opaque material of the eighth example.

FIG. 11A is a schematic diagram illustrating use of a scraper to scratch the liquid opaque material out of the ring-shaped recess according to a ninth example.

FIG. 11B is a schematic diagram showing the liquid opaque material of the ring-shaped recess being scratched by the scraper of the ninth example.

FIG. 12 is a schematic diagram showing a top portion of the stamping head attached by the liquid opaque material according to a tenth example.

FIG. 13 is a schematic diagram showing the lens body being put into the recess of the first plate according to an eleventh example.

FIG. 14A is a 3D schematic diagram showing the structure of the first plate in the eleventh example (top surface facing toward up).

FIG. 14B is a 3D schematic diagram showing the structure of the first plate according to the eleventh example (bottom surface facing toward up).

FIG. 15A is a schematic diagram showing the second plate stacked on the first plate according to a twelfth example.

FIG. 15B is a schematic diagram showing the jig after being overturned according to the twelfth example.

### DETAILED DESCRIPTION

To provide a better understanding of the present invention to users skilled in the technology of the present invention, preferred examples are detailed as follows. The preferred examples of the present invention are illustrated in the accompanying drawings with numbered elements to clarify the contents and effects to be achieved.

The present invention provides a lens which has the ability for eliminating scattered light, described in the following examples:

### Example 1

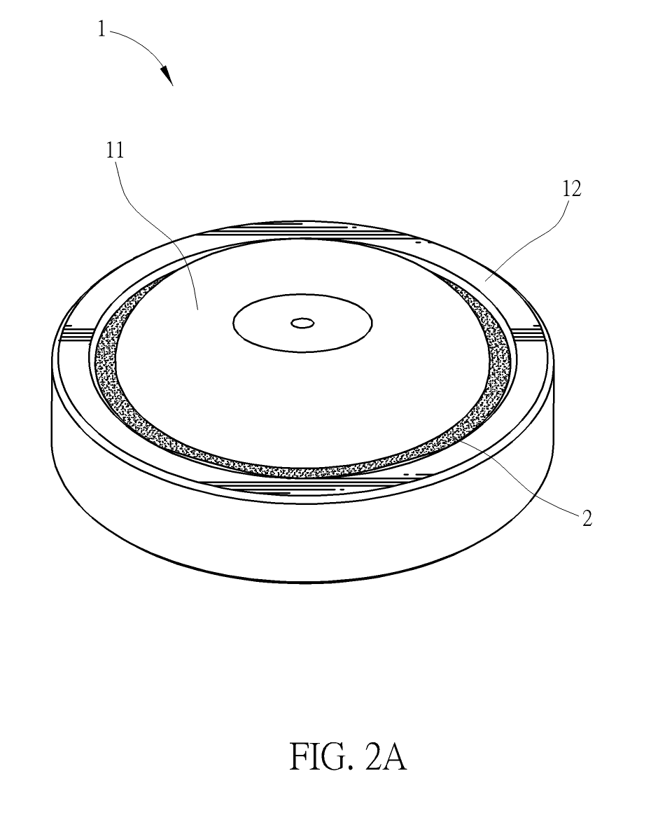

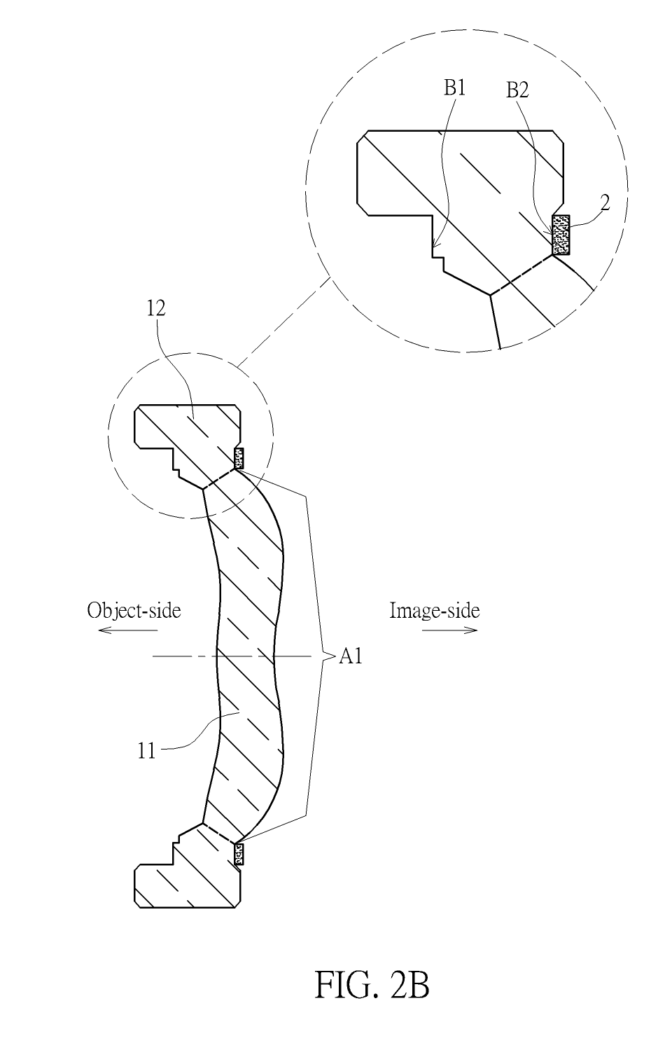

Please refer to FIGS. 2A and 2B, which illustrate a lens, comprising: a lens body 1, including an optical effective part 11 and an extending part 12, wherein the optical effective part 11 is the region A1 that allows an ideal image light to pass through, the extending part 12 is a ring-shaped structure surrounding the periphery region of the optical effective part 11 and extending outward from the periphery region of the optical effective part 11. Ideally, an image light will not pass through the extending part 12. The lens body 1 has an annular surface B1 facing an object-side and disposed on the extending part 12, and further has an annular surface B2 facing an image-side and disposed on the extending part 12. In other words, the lens body 1 has two surfaces, wherein one faces the object-side, and the other faces the image-side. The extending part 12 also has two annular surfaces: annular surface B1 and annular surface B2, which are disposed on two sides of the extending part 12, and face the object-side and the image-side, respectively. In this example, the annular surface B2 is a flat surface, and the annular surface B1 is a combination of a step surface and a tapered surface. It is noteworthy that the shape of the annular surface of the extending part 12 can be adjusted according to the demands for installing the lens, but in this technology scope, the annular surface is usually a flat surface, a tapered surface or the combination thereof.

The lens body further comprises an opaque layer 2, disposed on the annular surface B2 of the extending part 12. The material of the opaque layer 2 includes ink, paint, colored particles or other opaque materials. The opaque layer 2 can absorb most of the light, and reflects the remaining light. In this example, the opaque layer 2 comprises ink, which has better light-absorbing ability. In order to simplify the description, the examples shown in the following paragraph adopt ink as the preferred material of the opaque layer. In addition, the opaque layer 2 can be formed on the annular surface B2 through different methods, such as stamping on the annular surface B2, printing on the annular surface B2, or forming on the annular surface B2 through an evaporation process.

### Example 2

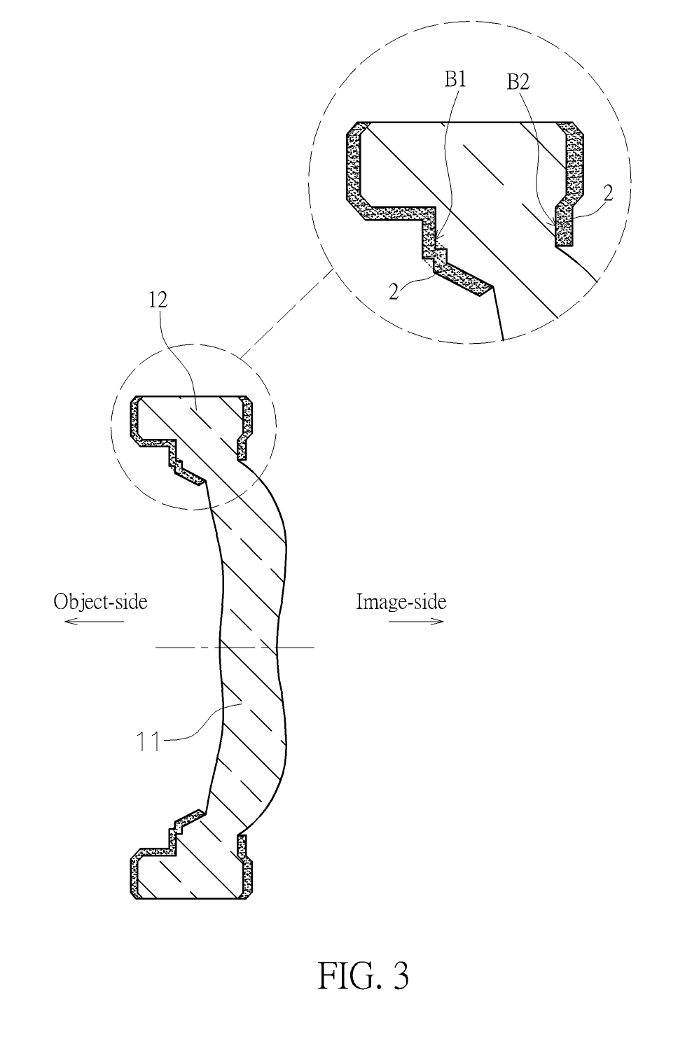

Refer to FIG. 3. The example is substantially similar to example 1. The difference between these two examples is that, in this example, the opaque layer 2 not only can be formed on the annular surface B2, but also can be formed on the annular surface B1. The materials of the opaque layer, and the method for forming the opaque layer on the annular surface B1 and annular surface B2 of the extending part 12 are similar to those described in example 1, and will be omitted here.

### Example 3

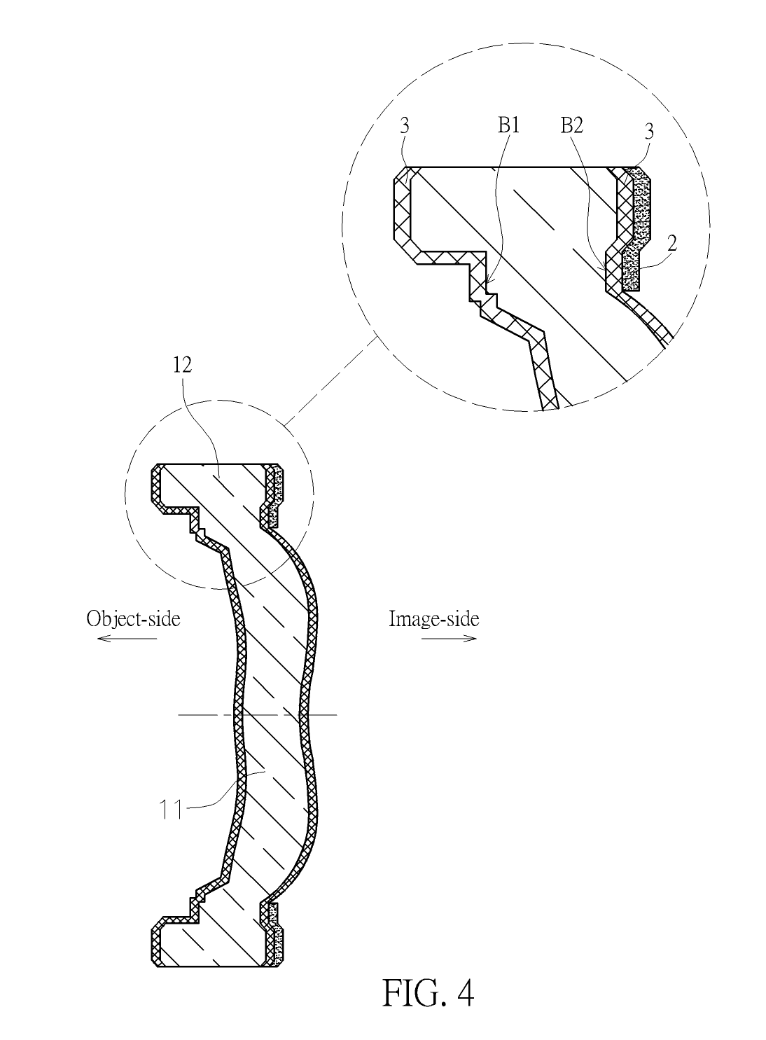

Refer to FIG. 4. The example is substantially similar to example 1. The difference between these two examples is that, in this example, an anti-reflective layer (transmittance improving layer) 3 covers the surface of the optical effective part 11 and the surface of the extending part 12 of the lens body 1, so as to improve the optical transmittance of the lens body 1. In this example, the opaque layer 2 is formed on the anti-reflective layer 3 which covers the annular surface B2.

### Example 4

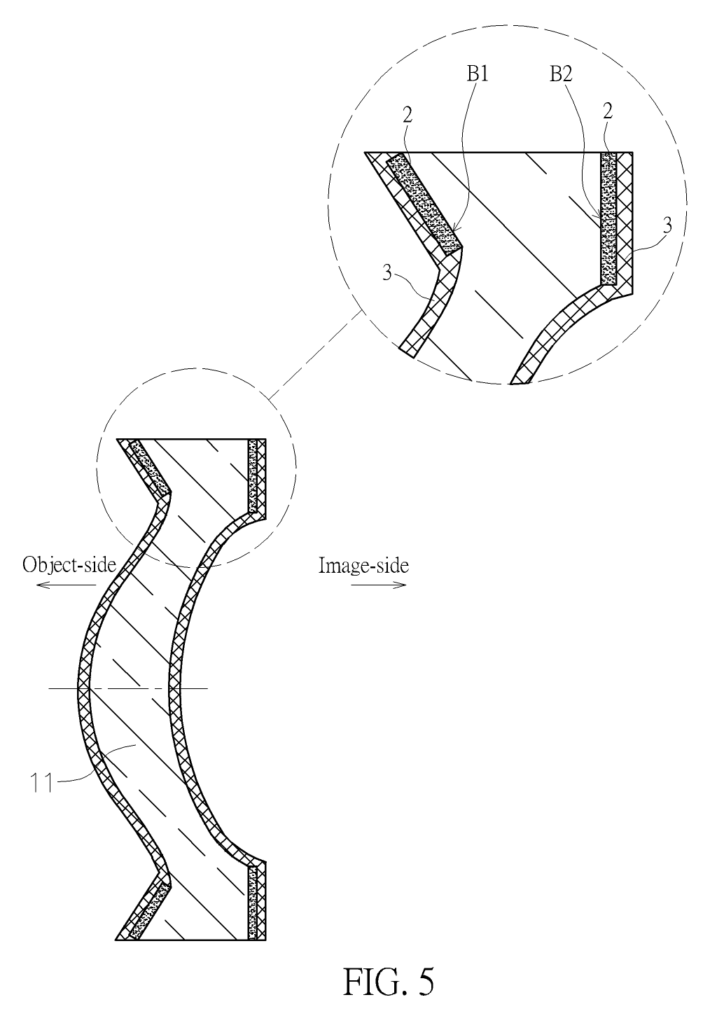

Refer to FIG. 5. The example is substantially similar to example 2. The difference between these two examples is that the shape of the optical effective part 11 and the shape of the extending part 12. In this example, the extending part 12 is a tapered surface. In addition, an anti-reflective layer 3 is further formed on the surface of the extending part 12 with the opaque layer 2, and further extended to cover the surface of the optical effective part 11. In other words, the anti-reflective layer 3 covers the whole surface of the lens body 1. In this example, the anti-reflective layer 3 covers the outer surface of the extending part 12. Compared with example 3, this example has a more difficult manufacturing process than example 3, but since the densified anti-reflective layer 3 covers the lens body 1, the opaque layer 2 will not be flaked, which increases the reliability of the lens during the assembling process and use.

### Example 5

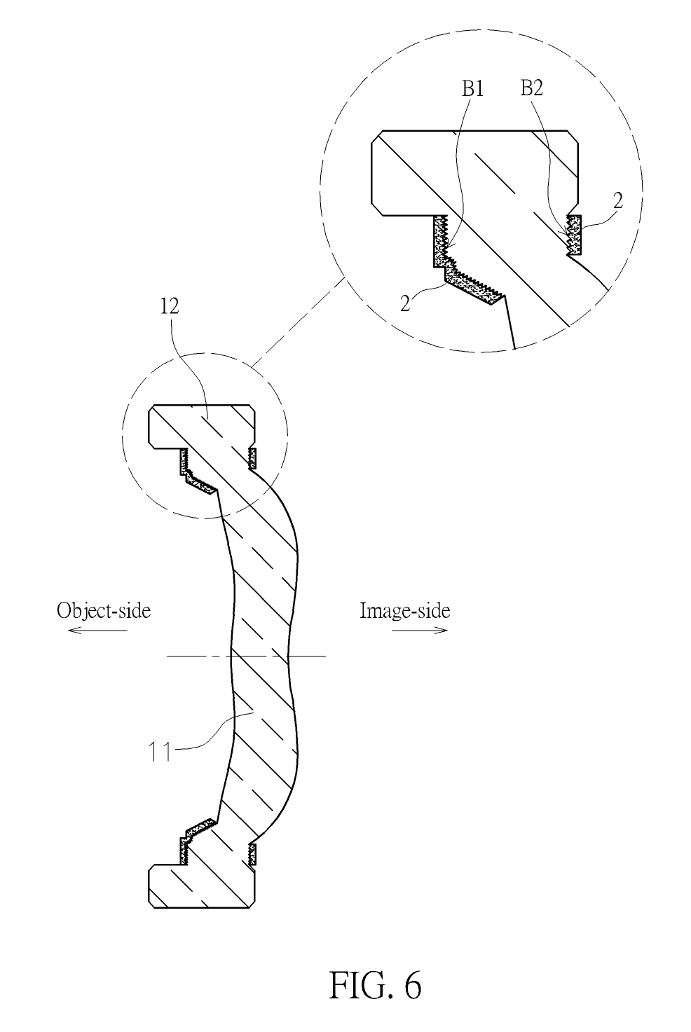

Refer to FIG. 6. The example is substantially similar to example 2. The difference between these two examples is that the annular surface B1 and the annular surface B2 of the extending part 12 in this example is not a smooth surface, but is a matte surface. Therefore, when the scattered light irradiates to the annular surface B1 or the annular surface B2, it will be more easily scattered by the matte surface, thereby preventing flares from being formed on the image plane. In addition, the opaque layer 2 has more binding force with the matte surface than with a smooth surface. If the opaque layer 2 is formed on a matte surface, the opaque layer 2 will not easily be flaked. Similarly, in the examples mentioned above, the annular surface can be treated by a matte process to form a matte surface.

### Example 6

Refer to FIG. 6 again. The example is substantially similar to example 5. It is noteworthy that, in this example, the material of the opaque layer 2 comprises colored particles, and is printed on the annular surface B1 or on the annular surface B2. The colored particles are non-transparent (preferably black) particles, mixed with glue, and then printed on the annular surface precisely through a printing head (sprinkler) controlled by a computer. In this example, the annular surface B1 and the annular surface B2 are matte surfaces, and the colored particles are printed on the annular surface B1 and the annular surface B2. Both the matte surface and the colored particles can scatter or absorb light effectively; therefore, the ability for scattering or absorbing the light is further improved, which can prevent flares.

The lenses mentioned above can be applied to an optical imaging lens set, wherein the opaque layer formed on the extending part can scatter or absorb light effectively, preventing flares and further improving the image quality. The optical lens set is described in the following example:

### Example 7

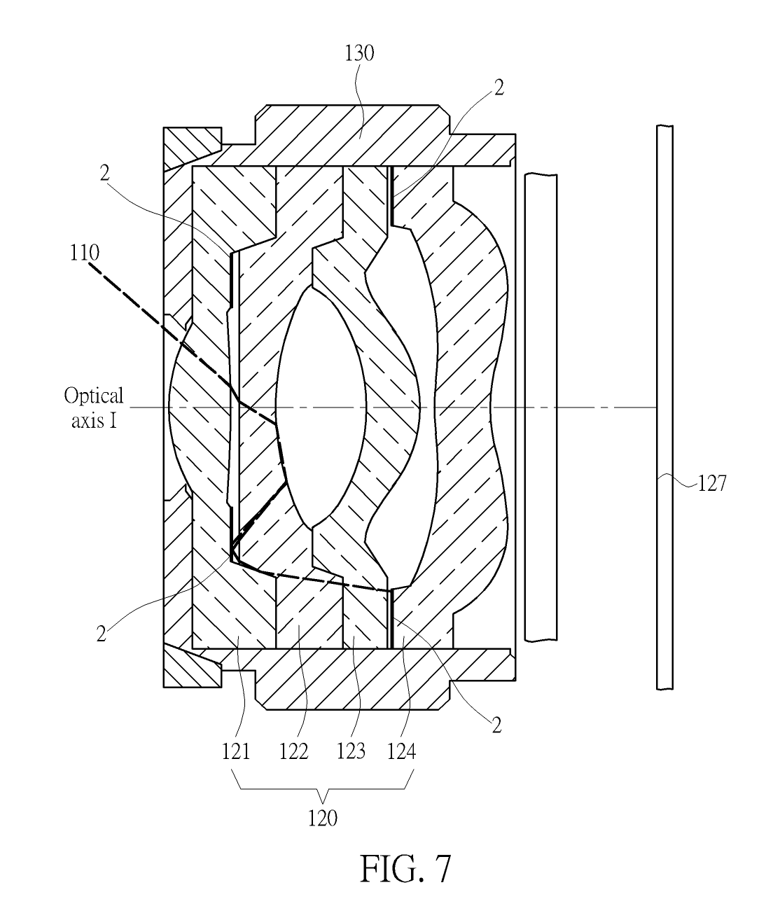

Refer to FIG. 7. This example provides an optical imaging lens set, comprising: a barrel 130, and an imaging component 120, disposed in the barrel 130. The imaging component 120 comprises a first lens element 121, a second lens element 122, a third lens element 123 and a fourth lens element 124 arranged along an optical axis I, wherein the second lens element 122 and the third lens element 123 are normal lenses, but the first lens element 121 and the fourth lens element 124 are the lenses mentioned in the example 1. The surface shape of each lens may not be exactly same as the lens in example 1: the optical effective part and the extending part of each lens body can be adjusted according to actual requirements.

Since the image-side surface of the first lens element 121 has the opaque layer 2 disposed on its annular surface, and the opaque layer 2 is very thin, a space remains between the extending part of the first lens element 121 and the extending part of the second lens element 122. The scattered light 110 can be reflected in this space, and will be shifted radically outwards, so the reflected light is easier to be blocked by the opaque layer 2 disposed on the object-side surface of the fourth lens element 124 after passing through the second lens element 122 and the third lens element 123.

Thus, the lens of the present invention has better ability for eliminating scattered light than the conventional lens.

There are different examples in the optical imaging lens set of the present invention. For example: in one case, only one lens is disposed in the barrel, and the lens is the lens shown in example 2, wherein the opaque layer is formed on both the object-side of the annular surface and the image-side of the annular surface of the extending part of the lens body. In another case, there are three lenses disposed in the barrel, wherein two of these lenses are normal lenses, and the other is the lens shown in example 3. In yet another case, there are five lenses disposed in the barrel, wherein two of these lenses are normal lenses, and the rest are the lenses shown in example 4. In another case, the optical imaging lens set is substantially similar to example 7, but there are five lenses disposed in the barrel, wherein all five lenses are the lens shown in example 5. In a further case, six lenses are disposed in the barrel, wherein two of these lenses are normal lenses, and the rest are the lens shown in example 6.

In the lens of the present invention, the method for forming the opaque layer is not limited, and varied methods can be performed to form the opaque layer. In the following example, the methods for forming the opaque layer through a stamping method and an evaporation method are described:

### Example 8

The example provides a method for forming a lens, comprising the following steps:

Step a. A substrate 30 is provided including a ring-shaped recess 32.

Step b. A liquid or gelatinous opaque material is filled in the ring-shaped recess 32. Similarly, the material of the opaque can be ink, paint, colored particles or glue. The following examples take ink as the material of the opaque layer.

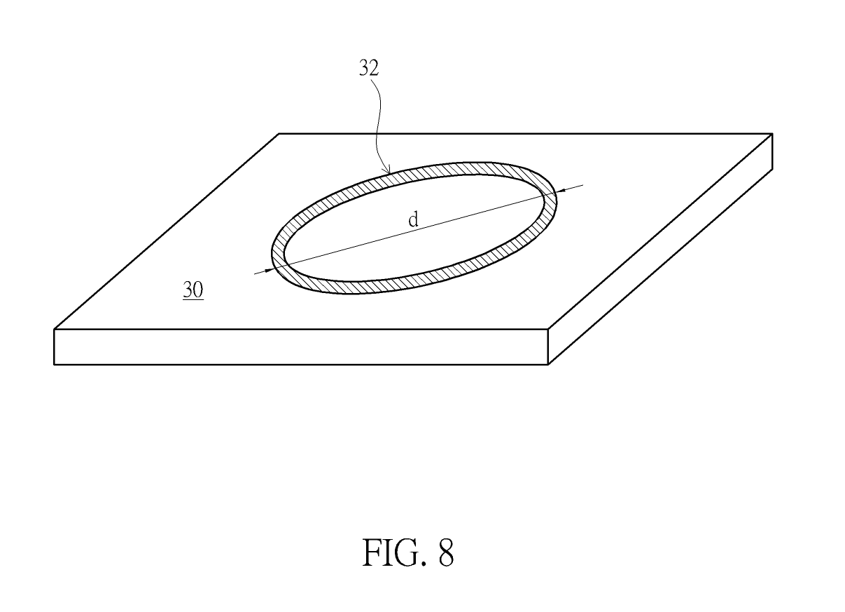

FIG. 8 is a schematic diagram showing a ring-shaped recess of a plate filled by a liquid opaque material. It is noteworthy that there is only one plate and one ring-shaped recess shown in FIG. 8, but in actual mass production processes, one plate may comprise a plurality of ring-shaped recesses disposed thereon and arranged in an array, and also include an array of stamping heads corresponding to these ring-shaped recesses. In this example, only one ring-shaped recess and one stamping head are described, but the number of the -shaped recesses and stamping heads is not limited thereto.

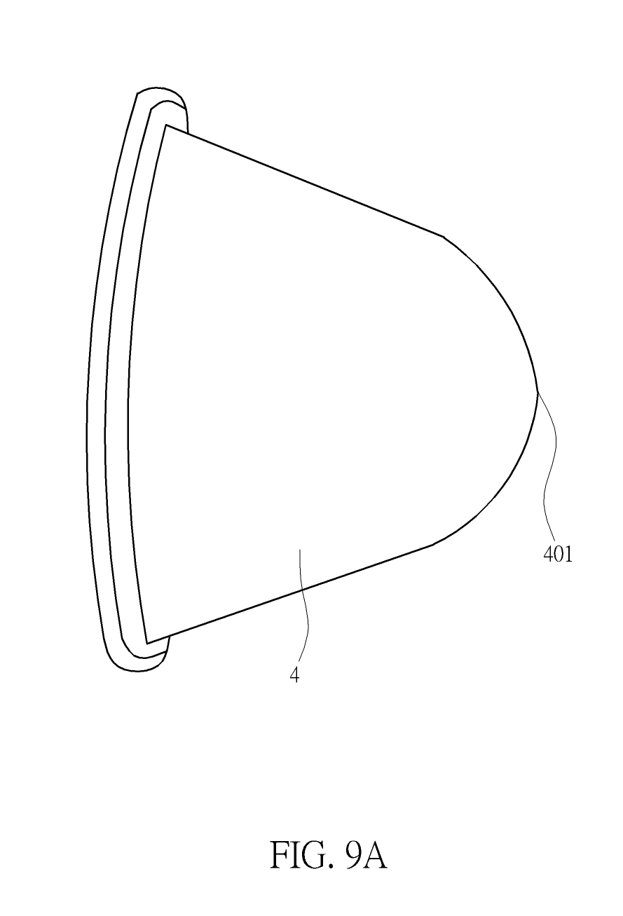

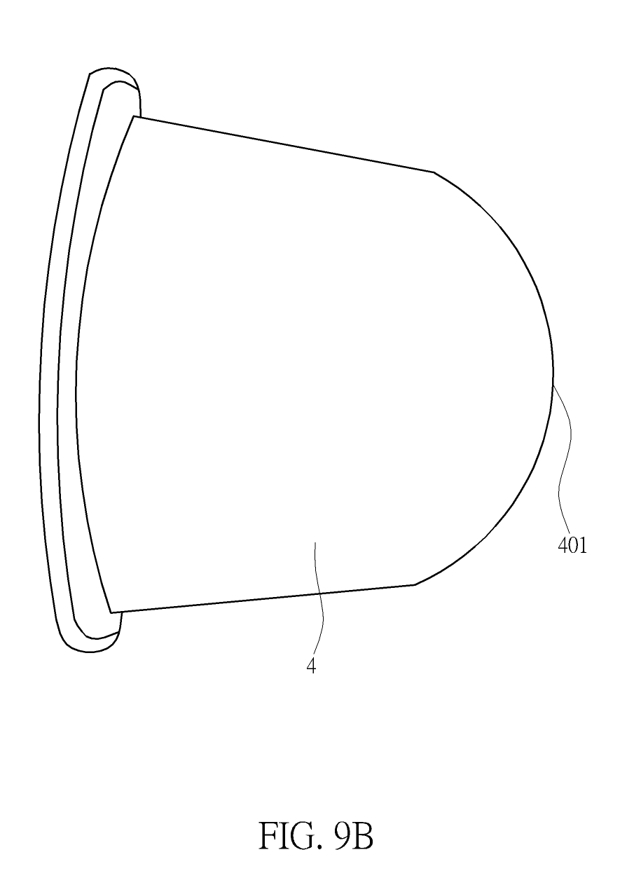

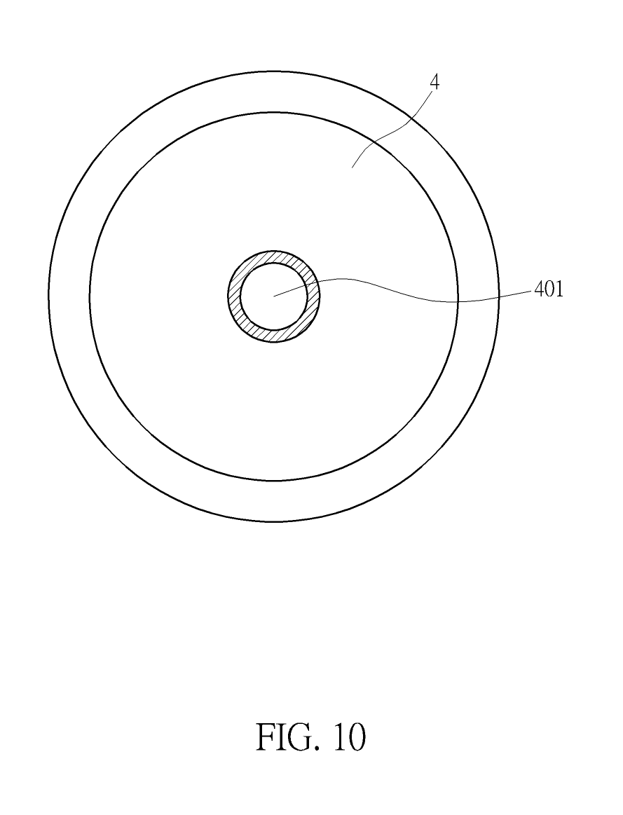

Step c. At least one stamping head is provided. The stamping head contacts the opaque material. Refer to FIG. 9A and FIG. 9B. The stamping head 4 may be bullet-shaped, hemispherical or other shapes, and has at least one top portion 401, wherein the ring-shaped opaque material is attached on the top portion 401 while the stamping head 4 contacts the opaque material (as shown in FIG. 10).

It is noteworthy that the stamping head 4 is of moderate flexibility and made of a hard material, such as rubber or synthetic resin. The top portion 401 has a certain elasticity but should not be too hard, to avoid damaging the lens body by excessive squeezing. It should also not be too soft, to avoid decreasing printing precision caused by the deformation of the top portion 401 during the stamping process.

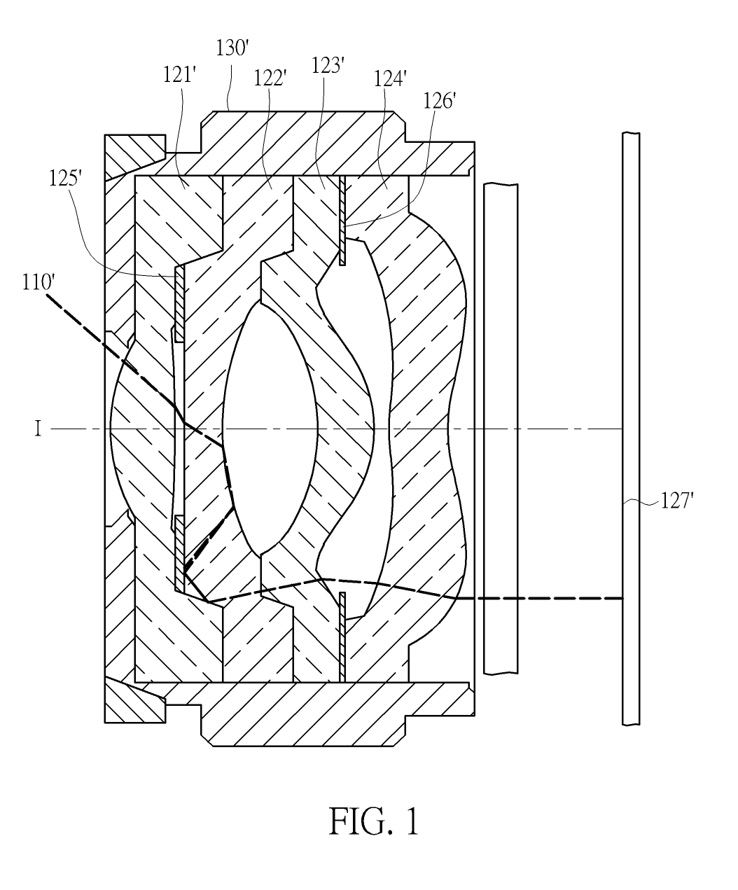

Step d. The stamping head 4 with the opaque material attached contacts a lens body 1, and the opaque material is printed on the lens body 1, wherein the lens body 1 includes an optical effective part 11 and an extending part 12. The optical effective part 11 is the region that allows light to pass through, the extending part 12 is a ring-shaped structure surrounding the periphery region of the optical effective part 11, and the extending part 12 has at least one annular surface, the opaque material being printed on one of the annular surfaces of the extending part 12 (such as the lens shown in FIGS. 1-6 above).

Preferably, before step d, the surface of the lens body 1 is pre-processed, and an anti-reflective layer is formed on the surface of the lens body, to improve the optical transmittance of the lens body 1 (such as the lens shown in example 3).

Step e. The stamping head is removed, and the opaque material is then cooled down to form a solid opaque layer.

It is noteworthy that step a to step e forms the opaque layer on only one annular surface of the extending part. In another case, if both sides of the annular surfaces of the extending part comprise the opaque layer, such as the lenses shown in example 2, example 4, example 5 or example 6, after the opaque layer is formed on one annular surface of the extending part, the lens is overturned, and steps a to step e are then performed again, to form the opaque layer on another side of the annular surface of the extending part.

### Example 9

This example provides a method for forming a lens. The example is substantially similar to example 8. After step b, the method further comprises:

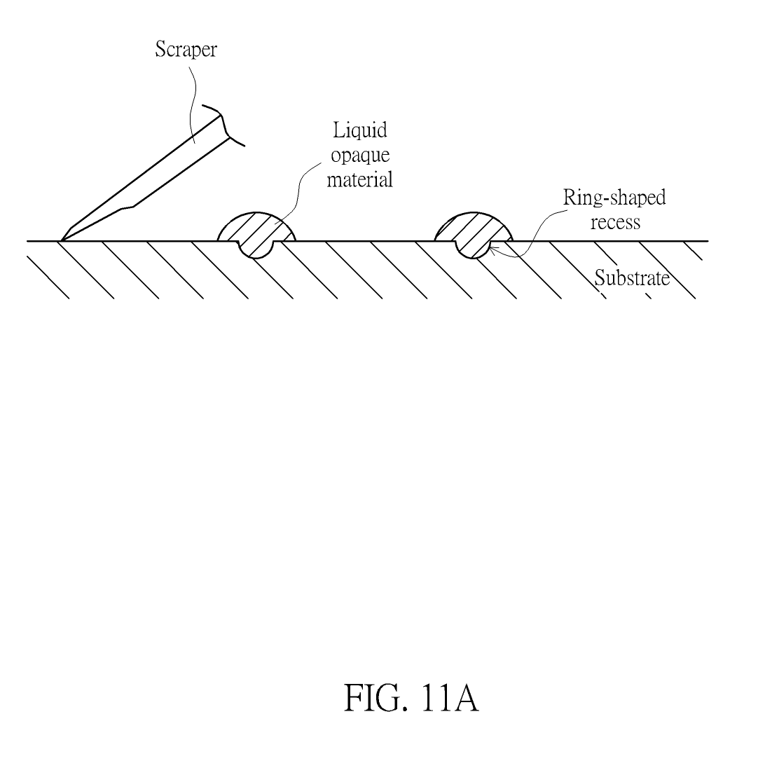

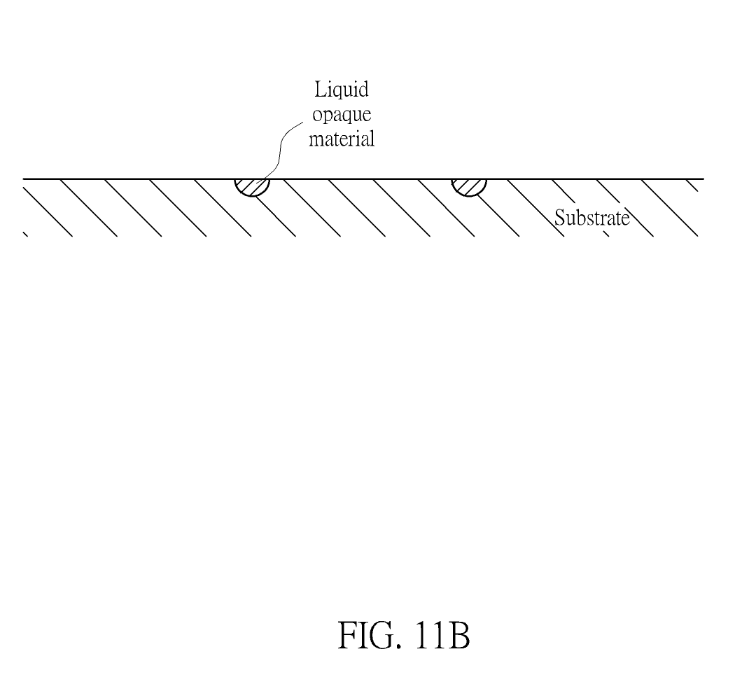

Step b1. The liquid opaque material disposed in the ring-shaped recess and on the surface of the substrate is scraped out through a scraper. As shown in FIG. 11A, after the liquid opaque material (such as ink) fills the ring-shaped recess, due to surface tension, some liquid opaque material may be higher than the plate surface, or spill outside the ring-shaped recess. Therefore, in this example, a scraper is used to remove parts of the liquid opaque material, and to make the top surface of the liquid opaque material even with the plate surface. In this way, the stamping precision when the top portion 401 of the stamping head 4 contacts the liquid opaque material in the ring-shaped recess can be improved.

### Example 10

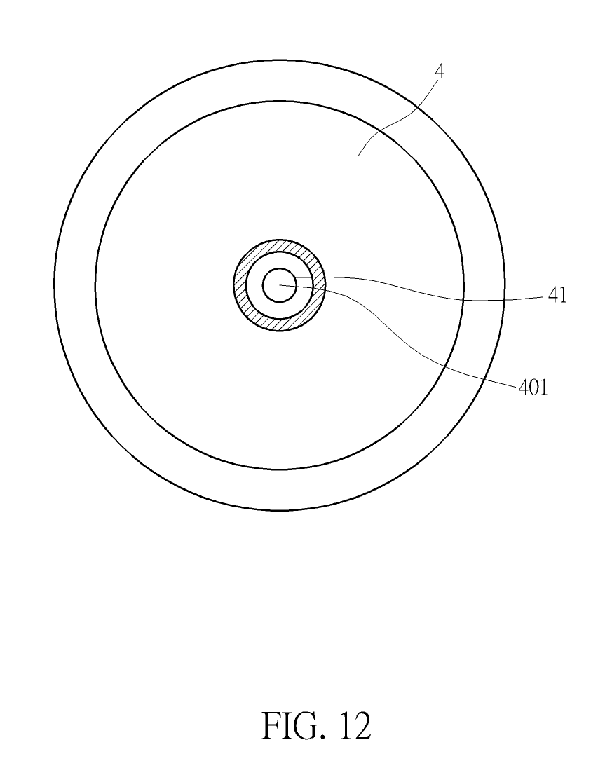

This example provides a method for forming a lens. The example is substantially similar to example 8. In this example, the top portion 401 further comprises a concave hole 41 disposed thereon. When the liquid opaque material is attached on the top portion 401, the liquid opaque material is disposed around the concave hole 41, and is ring-shaped, as shown in FIG. 12. In this way, when the top portion 401 stamps the lens body 1, the optical effective part 11 can be disposed in the concave hole 41, avoiding interference during the stamping process, and improving the stamping precision. Furthermore, the concave hole 41 can prevent the optical effective part 11 of the lens body 1 from being squeezed by the top portion 401 during the stamping process. In addition, this example can be combined with example 9.

Examples 8-10 mentioned above may further satisfy the limitation: the outer diameter d of the ring-shaped recess is larger than the outer diameter of the lens body 1. Therefore, the edge of the extending part 12 of the lens body 1 (including the outer edge) can be printed completely.

### Example 11

This example provides a method for forming a lens, comprising the following steps:

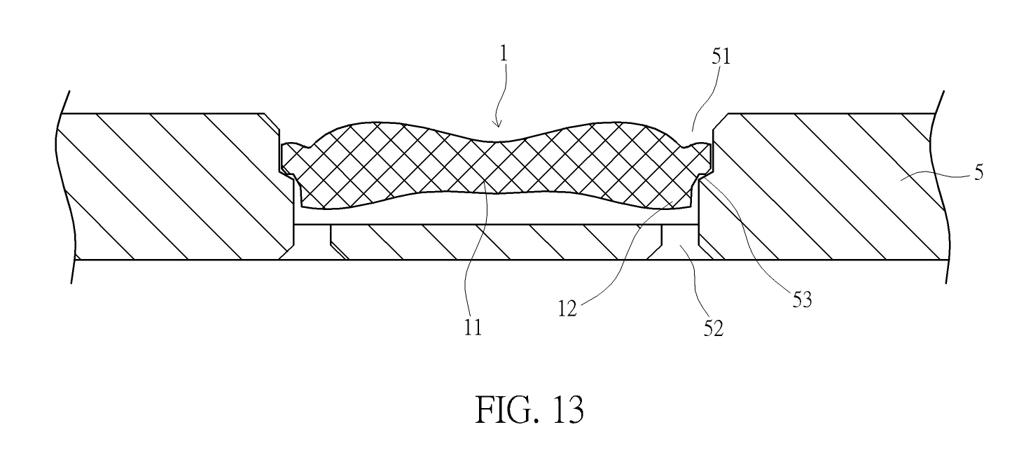

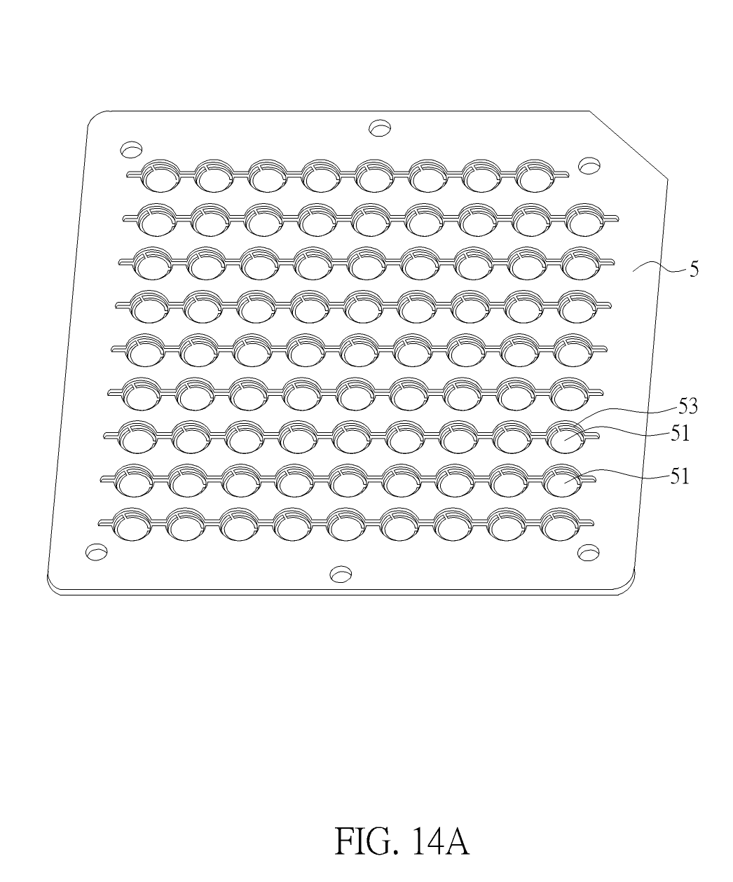

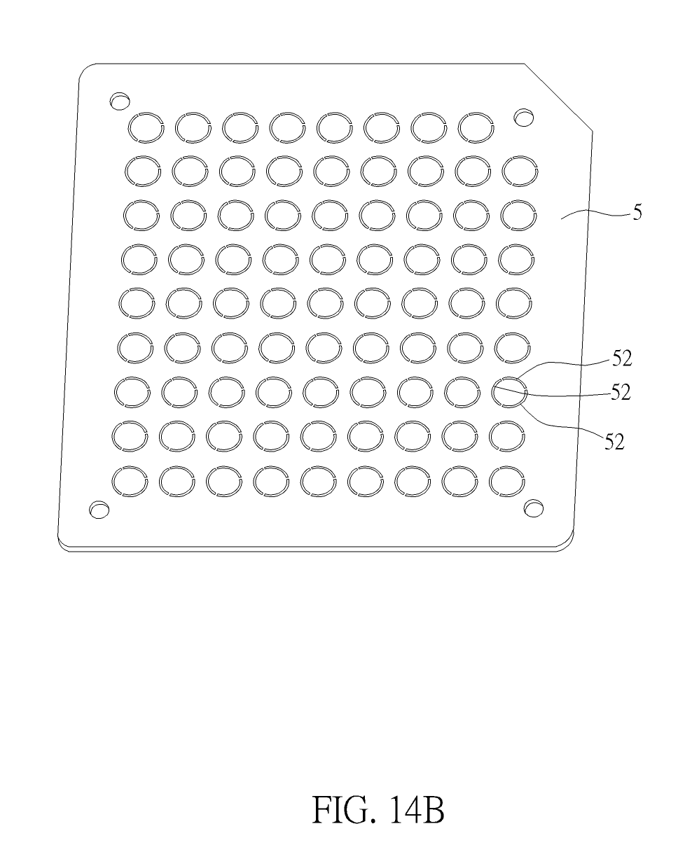

Step a. A jig is provided. Refer to FIG. 13, FIG. 14A and FIG. 14B. The jig comprises a first plate 5, which comprises a plurality of recesses 51 arranged in an array and disposed on the top surface of the first plate 5. In this example, three arc-shaped holes 52 are disposed on the inner surface of each recess 51, and the arc-shaped holes 52 are arranged in a ring and extend through the first plate 5. At least one supporting bump 53 is disposed in the recess 51 of the first plate 5.

It can be understood that this example includes a plurality of recesses 51 arranged in an array that can be applied to mass production processes, but the size of the recess 51 can be adjusted according to actual requirements. In addition, the size of the arc-shaped hole 52 in each recess 51 can be adjusted. In one case, there is only one arc-shaped hole 52 disposed in the recess 51, the arc-shaped hole 52 is a 9/10 arc-shaped penetrating hole, to shrink the connecting portion between the arc-shaped hole 52 and the first plate 5 as much as possible. In another case, there are two arc-shaped holes 52 disposed in the recess 51, each arc-shaped hole 52 is a 7/15 arc-shaped penetrating hole, and arranged symmetrically to compose a 14/15 ring. In this example, by adjusting the diameter of the arc-shaped hole 52, the shape and the area of the opaque layer formed in the following steps can be controlled.

Step b. Continue to refer to FIG. 13. A lens body 1 is put into the recess 51 of the first plate 5, the lens body 1 including an optical effective part 11 and an extending part 12, wherein the optical effective part 11 is the region that allows light to pass, and the extending part 12 is a ring-shaped structure surrounding the periphery region of the optical effective part 11, and having an annular surface. The extending part 12 of the lens body 1 in the recess 51 of the first plate 5 contacts the supporting bump 53 and is supported by the supporting bump 53. The position of the extending part 12 corresponds to the position of the arc-shaped holes 52 of the first plate 5.

Step c. An evaporation method is used to either vaporize a liquid opaque material into a gaseous opaque steam or sublimate a solid opaque material into the gaseous opaque steam. The gaseous opaque steam attaches on the lens body 1 through the arc-shaped holes 52, and the gaseous opaque steam is cooled down to forma solid opaque layer 2. Since the position of the extending part 12 corresponds to the position of the arc-shaped holes 52 of the first plate 5, the solid opaque layer 2 is only formed on the annular surface which faces the arc-shaped holes 52.

Similarly, the material of the opaque can be ink, paint, colored particles or glue. The following examples take ink as the material of the opaque layer.

Preferably, before step c, the surface of the lens body 1 is pre-processed, and an anti-reflective layer is formed on the surface of the lens body, to improve the optical transmittance of the lens body 1 (such as the lens shown in example 3).

It is noteworthy that, from step a to step c, the opaque layer is formed on only one annular surface of the extending part, such as the lenses mentioned in example 1 and example 3. In another case, for the purpose of both sides of the annular surfaces of the extending part comprising the opaque layer, such as the lenses shown in example 2, example 4, example 5 or example 6, after the opaque layer is formed on one annular surface of the extending part, the lens is overturned, and steps a to step c are then performed again, to form the opaque layer on another side of the annular surface of the extending part.

In the following example, the method for forming the opaque layer on both sides of the annular surface of the extending part is described:

### Example 12

This example provides a method for forming a lens, comprising the following steps:

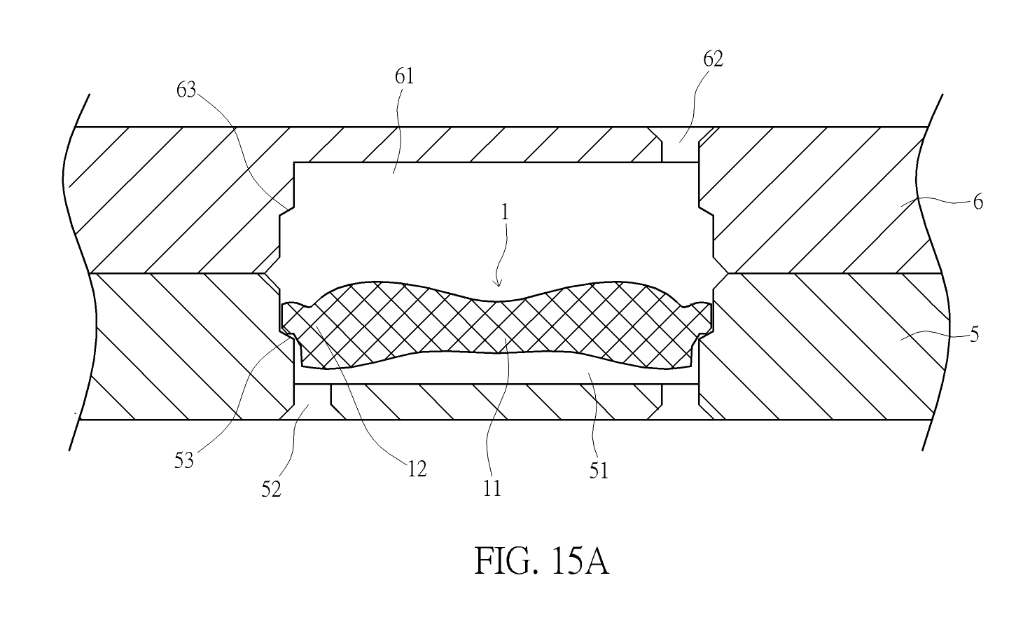

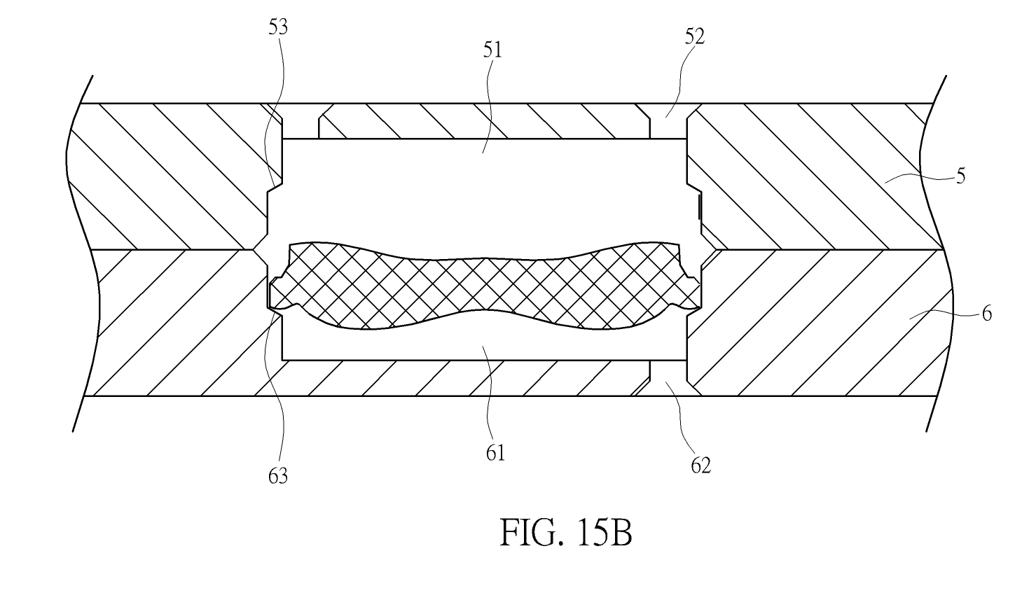

Step a. A jig is provided. Refer to FIG. 15A, FIG. 15B, FIG. 14A and FIG. 14B. The jig comprises a first plate 5 and a second plate 6. The first plate 5 comprises a plurality of recesses 51 arranged in an array and disposed on the top surface of the first plate 5. In this example, three arc-shaped holes 52 are disposed on the inner surface of each recess 51, and the arc-shaped holes 52 are arranged in a ring-shape and extend through the first plate 5. Similarly, the second plate 6 comprises a plurality of recesses 61 arranged in an array and disposed on the top surface of the second plate 6. In this example, three arc-shaped holes 62 are disposed on the inner surface of each recess 61, and the arc-shaped holes 62 are arranged in a ring-shape and extend through the second plate 6. At least one supporting bump 53 is disposed in the recess 51 of the first plate 5, and at least one supporting bump 63 is disposed in the recess 61 of the second plate 6.

In this example, the size of the recess 51 and recess 61 can be adjusted according to actual requirements. In addition, the size of the arc-shaped hole 52 in each recess 51 and the size of the arc-shaped hole 62 in each recess 61 can be adjusted. The arc-shaped holes are arranged in a ring.

Step b. Refer to FIG. 15A again. During step b, after the first plate 5 and the second plate 6 are separated from each other, the lens body 1 is put in the recess 51 of the first plate 5, and the second plate 6 is overturned, to make the second plate 6 stack on the first plate 5 and the top surface of the second plate 6 contact the top surface of the first surface 5, wherein both the bottom surface of the first plate 5 and the second plate 6 face outward. The lens body 1 includes an optical effective part 11 and an extending part 12, wherein the optical effective part 11 is the region that allows light to pass through, the extending part 12 is a ring-shaped structure surrounding the periphery region of the optical effective part 11, and has an annular surface. The extending part 12 of the lens body 1 in the recess 51 of the first plate 5 contacts the supporting bump 53 and is supported by the supporting bump 53. The position of the extending part 12 corresponds to the position of the arc-shaped holes 52 of the first plate 5, and the position of the extending part 12 corresponds to the position of the arc-shaped holes 62 of the second plate 6.

Step c. An evaporation method is used to either vaporize a liquid opaque material into a gaseous opaque steam or sublimate a solid opaque material into the gaseous opaque steam. The gaseous opaque steam attaches on the lens body 1 through the arc-shaped holes 52, and the gaseous opaque steam is cooled down to form a solid opaque layer 2. Since the position of the extending part 12 corresponds to the position of the arc-shaped holes 52 of the first plate 5, the solid opaque layer 2 is only formed on the annular surface which faces the arc-shaped holes 52.

Step d. The jig is overturned to make the first plate 5 stacks on the second plate 6. At this time, due to gravity, the lens body falls on the recess 61 of the second plate 6, contacts the supporting bump 63 and is supported by the supporting bump 63.

Step e. An evaporation method is used to either vaporize a liquid opaque material into a gaseous opaque steam or sublimate a solid opaque material into the gaseous opaque steam. The gaseous opaque steam attaches on the lens body 1 through the arc-shaped holes 62, and the gaseous opaque steam is cooled down to form a solid opaque layer 2. Since the position of the extending part 12 corresponds to the position of the arc-shaped holes 62 of the second plate 6, the solid opaque layer 2 is only formed on the annular surface which faces the arc-shaped holes 62.

In this example, the opaque layer can be formed on both sides of the annular surface of the extending part, such as the lenses shown in example 2, example 4, example 5 or example 6. Compared with example 11, the yield can be increased.

Similarly, the material of the opaque layer can be ink, paint, colored particles or glue. The following examples take ink as an example material of the opaque layer.

Preferably, before step c and e, the surface of the lens body 1 is pre-processed, and an anti-reflective layer is formed on the surface of the lens body, to improve the optical transmittance of the lens body 1 (such as the lens shown in example 3).

### Example 13

This example provides a method for forming a lens. The example is substantially similar to example 11. In this example, there is no supporting bump disposed in the recess of first plate 5, and the lens body 1 is directly supported by the inner surface of the recess 51. In addition, this example can be combined with example 12.

### Example 14

This example provides a method for forming a lens. The example is substantially similar to example 11. In this example, during step c and after the evaporation process is performed, the lens body 1 is rotated by a certain angle, and another evaporation process is then performed. During the evaporation process, parts of the annular surface of the extending part 12 will be blocked by the connecting portion between the first plate 5 and the arc-shaped holes 52, so the lens body 1 is rotated by certain angles. The gaseous opaque steam can attach on the blocked region, so the opaque layer 2 can be formed more completely and evenly.

Preferably, since the lens body 1 has a relatively small volume, it is adsorbed by a vacuum nozzle, and then rotated. Afterwards, the vacuum suction of the vacuum nozzle is released, and the lens body 1 is removed from the vacuum nozzle. This example can be combined with example 12.

### Example 15

This example provides a method for forming a lens. The example is substantially similar to example 11. In this example, during the step b, a protection film is further formed on the optical effective part of the lens body 1, and the lens body is then put into the recess 51 of the first plate 5. In this way, some spilled gaseous opaque steam will not be formed on the optical effective part 11. After the evaporation process of step c is performed, the protection layer is then removed. This example can be combined with example 12.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lens, comprising:
a lens body, including an optical effective part and an extending part, wherein the optical effective part is the region that allows light to pass through, the extending part is a ring-shaped structure surrounding the periphery region of the optical effective part, and the extending part has an annular surface; and
an opaque layer, disposed on at least one annular surface of the extending part.

2. The lens of claim 1, further comprising an anti-reflective layer disposed on the surface of the optical effective part and the extending part of the lens body.

3. The lens of claim 2, wherein the opaque layer is disposed on the anti-reflective layer which is disposed on the annular surface of the extending part.

4. The lens of claim 1, wherein the annular surface of the extending part is a matte surface.

5. The lens of claim 1, wherein the annular surface of the extending part comprises a plate surface, a tapered surface or the combination thereof.

6. The lens of claim 1, wherein the opaque layer is formed on the annular surface by a stamping method with a stamping head, a printing method, a sputtering method or an evaporation method.

7. An optical imaging lens set, comprising:
a barrel; and
an imaging component, disposed in the barrel, the imaging component comprising at least one lens arranged along an optical axis, and one of the lens of the imaging component is the lens of claim 1.

8. A method for forming a lens, comprising the following steps:
a) providing a substrate, the substrate including a ring-shaped recess;
b) filling an opaque material in the ring-shaped recess;
c) providing at least one stamping head which has at least one top portion, the stamping head contacting the opaque material and the opaque material being attached on the top portion;
d) making the stamping head with the opaque material contact a lens body, and printing the opaque material on the lens body, wherein the lens body includes an optical effective part and an extending part, the optical effective part is the region that allows light to pass through, the extending part is a ring-shaped structure surrounding the periphery region of the optical effective part, the extending part has at least one annular surface, and the opaque material is printed on one of the annular surfaces of the extending part; and
e) removing the stamping head, and cooling the opaque material down to form a solid opaque layer.

9. The method of claim 8, wherein step b further comprises:
scraping the opaque material disposed outside the ring-shaped recess and on the surface of the substrate through a scraper.

10. The method of claim 8, wherein in step a, the outer diameter of the ring-shaped recess of the substrate is larger than the outer diameter of the lens body.

11. The method of claim 8, wherein in step c, the top portion of the stamping head comprises a concave hole, and the opaque material is attached on the top portion of the stamping head around the concave hole, and is ring-shaped.

12. The method of claim 8, wherein during step d, the surface of the lens body is pre-processed, and an anti-reflective layer is disposed on the surface of the lens body thereby.

13. A method for forming a lens, at least comprising the following steps:
a) providing a jig comprising a first plate, the first plate comprising at least one recess disposed on the top surface of the first plate, and at least one arc-shaped hole disposed on the inner surface of the recess, wherein the arc-shaped holes are arranged in a ring-shape, and extend through the first plate;
b) putting a lens body into the recess, the lens body including an optical effective part and an extending part, wherein the optical effective part is the region that allows light to pass through, and the extending part is a ring-shaped structure, surrounding the periphery region of the optical effective part, and the extending part has an annular surface, the position of the extending part corresponding to the position of the arc-shaped hole of the first plate; and
c) using an evaporation method to either vaporize a liquid opaque material into a gaseous opaque steam or sublimate a solid opaque material into the gaseous opaque steam, the gaseous opaque steam attaching on the lens body through the arc-shaped hole, and the gaseous opaque steam cooling down to forma solid opaque layer.

14. The method of claim 13, wherein:
the jig further comprises a second plate, the second plate comprises at least one recess disposed on the top surface of the second plate and at least one arc-shaped hole disposed on the inner surface of the recess, the arc-shaped holes are arranged in a ring-shape, and extend through the second plate;
during step b, the first plate and the second plate are separated from each other, and the lens body is then put in the recess of the first plate and the second plate is overturned, so as to make the second plate stack on the first plate, the top surface of the second plate contact the top surface of the first surface, both the bottom surface of the first plate and the second plate face outwards, and the position of the extending part corresponds to the position of the arc-shaped hole of the second plate;
and the method further comprises the following steps:
d) overturning the jig to make the first plate stack on the second plate; and
e) using an evaporation method to either vaporize a liquid opaque material into a gaseous opaque steam or sublimate a solid opaque material into the gaseous opaque steam, the gaseous opaque steam attaches on the lens body through the arc-shaped hole of the second plate, and the gaseous opaque steam is cooled down to form a solid opaque layer.

15. The method of claim 13, further comprising at least one supporting bump disposed in the recess of the first plate, the extending part of the lens body in the recess of the first plate contacting the supporting bump and being supported by the supporting bump.

16. The method of claim 14, further comprising at least two supporting bumps disposed in the recess of the first plate and in the recess of the second plate respectively, the extending part of the lens body in the recess of the first plate or in the recess of the second plate contacting the supporting bump and being supported by the supporting bump.

17. The method of claim 15, wherein during step b, the surface of the lens body is pre-processed, and an anti-reflective layer is disposed on the surface of the lens body thereby.
